(19) United States
(12) Patent Application Publication
(10) Pub. No.: US 2014/0262020 A1
(43) Pub. Date: Sep. 18, 2014

(54) PRIMER COMPOSITIONS FOR IMPROVED ADHESION OF POLYMER SHEETS

(71) Applicant: Schott Corporation, (US)

(72) Inventor: Christopher Snively, Clarks Summit, PA (US)

(73) Assignee: Schott Corporation, Elmsford, NY (US)

(21) Appl. No.: 13/836,222

(22) Filed: Mar. 15, 2013

(51) Int. Cl. C09J 175/08

(52) U.S. Cl. CPC C09J 175/08
USPC 156/331.4; 524/590; 524/104; 156/331.7

(57) ABSTRACT

Primer compositions for adhering two sheets of polymer material to one another are provided. The primer compositions include polyurethanes that are the reaction product of an isocyanate, and at least one of a polyol, a chain extender, and a diamine. The polyurethanes may include pure polyurethanes, or commercially available varieties that may include other additives. The premier compositions are well-suited for adhering polycarbonate and polyurethane sheets together for use in transparent armor applications, as they help to ensure a very strong bond between the two sheets, and resist delamination.

### BACKGROUND OF THE DISCLOSURE

1. Field of the Disclosure

The present disclosure relates to a primer composition for bonding two materials. More particularly, the present disclosure relates to a primer composition particularly advantageous for bonding polycarbonate to polyurethane.

2. Description of the Related Art

Transparent armor is often used in military and defense applications to protect personnel from incoming ballistics. This armor is often made of layers of glass, adhesive, and polymer. One common problem with existing armor is that it delaminates when subjected to challenging field conditions, meaning that the layers separate. If the armor delaminates, it is unusable, and needs to be replaced. As this armor is very expensive and, more importantly, it protects human life, there is a continuing need to ensure that the layers of the armor will stay adhered to one another for as long as possible, and under a host of very challenging field conditions.

The present disclosure provides a primer composition that addresses the above-described disadvantages.

### SUMMARY OF THE DISCLOSURE

The present disclosure provides a primer composition that is applied to a first polymer layer to provide greater adhesion to a second polymer layer, and induces a chemical reaction so that there is a strong chemical bond between the two polymer layers.

In a preferred embodiment, the present disclosure also provides a primer composition comprising a polyurethane and a solvent. The polyurethane is a reaction product of an isocyanate and at least one additional component selected from the group consisting of a polyol, a chain extender having two hydroxyl groups, and a diamine. In the more preferred embodiment, the polyurethane is present in the primer composition in an amount of 1.6 to 24 grams per liter of solvent.

The present disclosure further provides a primer composition consisting of a polyurethane and a solvent. The polyurethane is a reaction product of an isocyanate, a polyol, and at least one of a chain extender having two hydroxyl groups and a diamine. The polyurethane is present in the primer composition in an amount of 1.6 to 24 grams per liter of solvent. The isocyanate is an aliphatic diisocyanate selected from the group consisting of diisophorone diisocyanate, 1,4-cyclohexyl diisocyanate, dicyclohexylmethane-4,4′-diisocyanate, and any mixtures thereof. The polyol is a hydroxyl-terminated polyalkylether selected from the group consisting of polyethylene glycol, polypropylene glycol, polytetramethylene glycol, and any mixtures thereof. The chain extender having two hydroxyl groups is selected from the group consisting of ethylene glygol, propylene glycol, butanediol, hexanediol, 1,4-cyclohexanediol, 2,2,4,4-tetramethyl-1,3-cyclobutanediol, and any mixtures thereof. The solvent is selected from the group consisting of methylene chloride, dichloroethane, dioxolane, N-methylpyrrolidone, tetrahydrofuran, dioxane, dimethylformamide, m-cresol, chloroform, cyclohexanone, pyridine, dimethylsulfoxide, and any mixtures thereof.

The present disclosure further provides a method of adhering a first polymer sheet to a second polymer sheet, comprising the steps of applying a primer composition to a first side of the first polymer sheet, and contacting the first side of the first polymer sheet with the second polymer sheet to form a laminate. The primer composition preferably comprises a polyurethane and a solvent. The polyurethane is a reaction product of an isocyanate and at least one additional component selected from the group consisting of a polyol, a chain extender having two hydroxyl groups, and a diamine. In a more preferred embodiment, the polyurethane is present in the primer composition in an amount of 1.6 to 24 grams per liter of solvent.

### BRIEF DESCRIPTION OF THE DRAWINGS

FIG. 1 is a schematic drawing of an armor laminate using the primer composition of the present disclosure; and

FIG. 2 shows conceptual drawings of a polycarbonate layer, a polyurethane layer, and the interface between the two with and without application of the primer composition of the present disclosure.

### DETAILED DESCRIPTION OF THE DISCLOSURE

The present disclosure provides a primer composition that addresses the problem of delamination in layered transparent armor laminates. The primer composition comprises a polyurethane dissolved in a solvent. The primer may also consist solely of the polyurethane and the solvent. Applying the primer of the present disclosure between a polyurethane adhesive layer and a polycarbonate layer in a transparent armor laminate significantly addresses the problem of delamination, while also preserving critical optical properties (e.g., haze) in the case of a transparent armor.

In transparent armor laminates, a polycarbonate layer will often be adjacent to a polyurethane layer. The polyurethane layer acts as an adhesive and is located between the polycarbonate layer and a hard layer that can be made of glass or glass-ceramic. When a ballistic strikes the laminate, the polycarbonate layer can act as a spall to catch any fragments of the ballistic or the solid layer.

Referring to the Figs and, in particular, FIG. 1, there is shown an example of a transparent armor laminate generally represented by reference numeral 5. Laminate 5 has polycarbonate layer 10 as the strike face to meet the ballistic, polyurethane layer 12, and solid layer 14. Laminate 5 can also have additional polyurethane and polycarbonate layers (not shown) on the safe side of hard layer 14 (i.e., opposite the incoming ballistic), to catch spall and prevent the spall from injuring personnel located on the safe side. For ease of description, the primer compositions of the present disclosure are discussed below in conjunction with laminate 5, but the primer compositions of the present disclosure may be used in any application where it is desired to improve adhesion between a polymer layer and a polyurethane adhesive layer.

Transparent armor laminate 5 will often be used in very rigorous applications where it will be subjected to extreme weather, such as very high and/or very low heat, or high humidity. These conditions normally cause armor laminates to undergo significant stress, and may cause the polycarbonate layer(s) 10 to become delaminated from the solid layer 14. When delamination occurs, laminate 5 has failed, and needs to be replaced. Such replacement can be very expensive, and depending on the armor's use, may be impossible to do in a particular field situation. The primers of the present disclosure address this situation.

The polyurethanes of the present disclosure are thermoplastic polyurethanes that are the reaction product of three general classes of compound: 1) an isocyanate, such as diisocyanate; and at least one of 2) a polyol, and 3) a chain extender. In one embodiment, the polyurethane is a reaction product of a diisocyanate, a polyol, and a chain extender. The polyurethanes used in the primer composition may be the same as the polyurethanes used in layer 12, or they may be different.

The diisocyanate component can be one or more compounds that fall into the general class of aliphatic diisocyanates. These can include, but are not limited to, diisophorone diisocyanate, 1,4-cyclohexyl diisocyanate, dicyclohexylmethane-4,4′-diisocyanate. The polyurethane can include either a single diisocyanate or a mixture of diisocyanates. Diisocyanates may also be used for the purpose of reducing chain length and improving processability.

The polyol component can include one or more compounds that fall into the general category of hydroxyl-terminated polyalkylethers. Examples of polyols include, but are not limited to, polyethylene glycol, polypropylene glycol, and polytetramethylene glycol. The polyols in the polyurethanes of the present disclosure have average molecular weights that are typically in the range of 500-3000 Daltons. The polyurethane can include either a single polyol or a mixture of polyols.

The chain extender can be any compound possessing two hydroxyl groups that are able to be reacted chemically. Examples of chain extenders include, but are not limited to, ethylene glygol, propylene glycol, butanediol, hexanediol, 1,4-cyclohexanediol, 2,2,4,4-tetramethyl-1,3-cyclobutanediol. The polyurethane can include either a single chain extender or a mixture of chain extenders.

In addition to polyurethanes, polyurethane-ureas can be used. Polyurethane-ureas have similar chemistry to the polyurethanes described here, except that some or all of the chain extender is replaced with a diamine, or a mixture of diamines.

Alternatively, commercially available polyurethanes may be used. These are typically composed of not only the three components described above, but also include additives such as, but not limited to, one or more catalysts, adhesion promoters, antioxidants, UV light absorbers, waxes, thickening agents, dyes, pigments, that can be either be compounded with the polymer or covalently reacted into the chain structure. Suitable commercially available polyurethanes include the Krystalflex® PE429, PE399, and PE501 polyurethanes from Huntsman, and the Duraflex® A4700 and X2260 polyurethanes from Deerfield. As used from this point forward in the present disclosure, the term “polyurethanes” or “thermoplastic polyurethanes” refers to polyurethanes that include only the three reaction components listed above (isocyanate, polyol and/or chain extender), those that also include polyurethane-ureas, and those commercially available polyurethanes that may include additives.

The solvent used in the primer compositions must have the ability to dissolve both the polyurethane (or polyurethane-urea) and polycarbonate. The solvent must also be a thermodynamically good solvent for the polyurethane(-urea), such that the polymer chains are well-solvated and possess an extended chain conformation (as opposed to a bundled or tangled formation) at the molecular level.

Suitable specific solvents for the primer compositions of the present disclosure include methylene chloride, dichloroethane, dioxolane, N-methylpyrrolidone, tetrahydrofuran, dioxane, dimethylformamide, m-cresol, chloroform, cyclohexanone, pyridine, and dimethylsulfoxide. The primer compositions may include two or more of these solvents. Mixtures of solvents can often be helpful to tune the properties of the final primer compositions—e.g., balancing haze and appearance with improved adhesion.

The concentration of polymer dissolved in the solvent is limited on both the high and low sides. There must be sufficient surface coverage of the primer polyurethane to affect increased adhesion. The lower limit of concentration of polyurethane in the solvent must be determined experimentally and depends on the specific polymers used for both the primer composition and layer 12, as well as the method of application to the layers of laminate 5. Conversely, if the primer composition contains too high a concentration of polyurethane, the viscosity may be high enough to interfere with the application of the primer—i.e. it may not be possible to form a thin enough layer of the primer or fibers may be produced when spraying, leading to unwanted optical features in the armor. In one embodiment, the concentration of polyurethane in solvent can be from 1.6 to 24 grams of polyurethane per liter of solvent, or any subranges therebetween.

The primers of the present disclosure function by increasing the contact area between polycarbonate and polyurethane on a molecular level. This molecular-level miscibility increases adhesion by both increasing the contact area and increasing the possibility of forming chain entanglements between the polyurethane and polycarbonate layers. FIG. 2 shows a conceptualization of this entanglement between polycarbonate layer 10 and polyurethane layer 12, at interphase 11. These entanglements act as physical crosslinks, increasing adhesion like a molecular-level version of Velcro®. Once treated with the primer composition, the polycarbonate layer 10 has a thin layer of polyurethane on its surface. During autoclaving, the polyurethane interlayer 12 melts and diffuses into the polyurethane primer at interphase 11. Because the polyurethanes are similar (or identical) in molecular structure, interdiffusion is thermodynamically favorable, and a continuous polyurethane phase can be formed at interface 11.

An unprimed polycarbonate layer 10 that is autoclaved in contact with a polyurethane interlayer 12 has a sharp interface between the two. The contact area between the two materials is limited to the surface area between the two layers being laminated. A primed polycarbonate layer 10, on the other hand, has a continuous, finite length interphase 11 between the polycarbonate layer 10 and the polyurethane layer 12. The increased contact area within interphase 11 leads to enhanced adhesion between layers 10 and 12.

It is also important to note that adhesion is not the only important consideration when developing the primer composition of the present disclosure. The primer composition should not affect the optical properties of the armor adversely. Haze can be a concern with some primer formulations, and this should be taken in to consideration.

The primers of the present composition can be applied through any of several methods, including spray-on or roll coating. The primer compositions will be applied to polycarbonate layer 10 first, and then polyurethane layer 12 is applied on top. When the primer compositions are applied via methods other than spray-coating, the polyurethane concentration in the primer may be a little higher than it otherwise would be. At high polyurethane concentrations, as noted above, the primer composition can become very viscous, and it can be difficult to apply a highly viscous composition via spray-coating.

Following are example primer compositions. The armor samples using the example primer compositions given here were characterized for both adhesion strength and optical haze. Adhesion strength was determined by measuring the force required to pull apart two primed polycarbonate substrates that were bonded in a lap shear configuration with a commercially available thermoplastic polyurethane. Haze measurements were carried out with a BYK-Gardner Hazegard instrument using samples of primed polycarbonate bonded with a commercially available thermoplastic polyurethane.

### Example 1

A primer was prepared using a commercially available thermoplastic polyurethane, PE399 from Huntsman. The primer was composed of a solution of PE399 in N-methylpyrrolidone at a concentration of sixteen grams per liter. The primer was applied to polycarbonate samples using a spray technique. The measured adhesion strength was found to be 1850 Newtons, as compared to 1600 Newtons for samples prepared without primer.

### Example 2

A primer was prepared using a commercially available thermoplastic polyurethane, PE429 from Huntsman. The primer was composed of a solution of PE429 in dichloroethane at a concentration of 8 grams per liter. The primer was applied to polycarbonate samples using a spray technique. The measured haze was found to be 1.4%, which is comparable within experimental error to the value obtained from a control sample prepared without primer.

In addition to the two Examples discussed above, specific combinations that have shown high adhesion include X2260 and PE399 polyurethanes dissolved in the solvents N-methylpyrrolidone, dichloroethane, and methylene chloride over the range of concentrations from 1.6 to 24 g/l. These give a maximum load in lap shear testing of about 1.7-2.1 kilonewtons (kN), whereas a control sample (i.e., with no primer) breaks around 1.4-1.6 kN. PE429 at the lowest concentration examined, 1.6 g/l, also showed some improvement, around 1.7-1.8 kN.

It should be noted that certain combinations of the above-recited polyurethanes and solvents at certain weight ranges may not produce satisfactory results. For example, some primer compositions made with the PE429 polyurethane in N-methylpyrrolidone, dichloroethane, and methylene chloride at concentrations above 1.6 g/l had maximum load values around 1.1-1.5 kN, below that of the controls. The above-recited examples were shown to have satisfactory results.

While the present disclosure has been described with reference to one or more particular embodiments, it will be understood by those skilled in the art that various changes may be made and equivalents may be substituted for elements thereof without departing from the scope thereof. In addition, many modifications may be made to adapt a particular situation or material to the teachings of the disclosure without departing from the scope thereof. Therefore, it is intended that the disclosure not be limited to the particular embodiment(s) disclosed as the best mode contemplated for carrying out this disclosure.

1. A primer composition, comprising:
a polyurethane, wherein said polyurethane is a reaction product of an isocyanate and at least one additional component selected from the group consisting of a polyol, a chain extender having two hydroxyl groups, and a diamine; and
a solvent,
wherein said polyurethane is present in the primer composition in an amount of 1.6 to 24 grams per liter of solvent.

2. The primer composition of claim 1, wherein said isocyanate is an aliphatic diisocyanate.

3. The primer composition of claim 2, wherein said aliphatic diisocyanate is selected from the group consisting of diisophorone diisocyanate, 1,4-cyclohexyl diisocyanate, dicyclohexylmethane-4,4′-diisocyanate, and any mixtures thereof.

4. The primer composition of claim 1, wherein said polyol is a hydroxyl-terminated polyalkylether.

5. The primer composition of claim 4, wherein hydroxyl-terminated polyalkylether is selected from the group consisting of polyethylene glycol, polypropylene glycol, polytetramethylene glycol, and any mixtures thereof.

6. The primer composition of claim 1, wherein said chain extender having two hydroxyl groups is selected from the group consisting of ethylene glygol, propylene glycol, butanediol, hexanediol, 1,4-cyclohexanediol, 2,2,4,4-tetramethyl-1,3-cyclobutanediol, and any mixtures thereof.

7. The primer composition of claim 1, wherein said solvent is selected from the group consisting of methylene chloride, dichloroethane, dioxolane, N-methylpyrrolidone, tetrahydrofuran, dioxane, dimethylformamide, m-cresol, chloroform, cyclohexanone, pyridine, dimethylsulfoxide, and any mixtures thereof.

8. The primer composition of claim 1, wherein said polyurethane is the reaction product of said isocyanate, said polyol, and at least one of said chain extender having two hydroxyl groups and said diamine.

9. The primer composition of claim 1, the composition consists of said polyurethane and said solvent.

10. A method of adhering a first polymer sheet to a second polymer sheet, comprising the steps of:
applying a primer composition to a first side of the first polymer sheet; and
contacting said first side of the first polymer sheet with the second polymer sheet to form a laminate,
wherein said primer composition comprises:
a polyurethane, wherein said polyurethane is a reaction product of an isocyanate and at least one additional component selected from the group consisting of a polyol, a chain extender having two hydroxyl groups, and a diamine; and
a solvent,
wherein said polyurethane is present in the primer composition in an amount of 1.6 to 24 grams per liter of solvent.

11. The method of claim 10, further comprising the step of heating said laminate to induce a chemical bond between the first polymer sheet and the second polymer sheet.

12. The method of claim 10, wherein said isocyanate is an aliphatic diisocyanate selected from the group consisting of diisophorone diisocyanate, 1,4-cyclohexyl diisocyanate, dicyclohexylmethane-4,4′-diisocyanate, and any mixtures thereof,
wherein said polyol is a hydroxyl-terminated polyalkylether selected from the group consisting of polyethylene glycol, polypropylene glycol, polytetramethylene glycol, and any mixtures thereof, and
wherein said chain extender having two hydroxyl groups is selected from the group consisting of ethylene glygol, propylene glycol, butanediol, hexanediol, 1,4-cyclohexanediol, 2,2,4,4-tetramethyl-1,3-cyclobutanediol, and any mixtures thereof.

13. The method of claim 12, wherein said solvent is selected from the group consisting of methylene chloride, dichloroethane, dioxolane, N-methylpyrrolidone, tetrahydrofuran, dioxane, dimethylformamide, m-cresol, chloroform, cyclohexanone, pyridine, dimethylsulfoxide, and any mixtures thereof.

14. The method of claim 10, wherein said polyurethane is the reaction product of said isocyanate, said polyol, and at least one of said chain extender having two hydroxyl groups and said diamine.

15. The method of claim 10, wherein the composition consists of said polyurethane and said solvent.

16. The method of claim 10, wherein the first polymer sheet comprises polycarbonate, and the second polymer sheet comprises polyurethane.

17. A primer composition, consisting of:
a polyurethane, wherein said polyurethane is a reaction product of an isocyanate, a polyol, and at least one of a chain extender having two hydroxyl groups and a diamine; and
a solvent,
wherein said polyurethane is present in the primer composition in an amount of 1.6 to 24 grams per liter of solvent,
wherein said isocyanate is an aliphatic diisocyanate selected from the group consisting of diisophorone diisocyanate, 1,4-cyclohexyl diisocyanate, dicyclohexylmethane-4,4′-diisocyanate, and any mixtures thereof,
wherein said polyol is a hydroxyl-terminated polyalkylether selected from the group consisting of polyethylene glycol, polypropylene glycol, polytetramethylene glycol, and any mixtures thereof,
wherein said chain extender having two hydroxyl groups is selected from the group consisting of ethylene glygol, propylene glycol, butanediol, hexanediol, 1,4-cyclohexanediol, 2,2,4,4-tetramethyl-1,3-cyclobutanediol, and any mixtures thereof, and
wherein said solvent is selected from the group consisting of methylene chloride, dichloroethane, dioxolane, N-methylpyrrolidone, tetrahydrofuran, dioxane, dimethylformamide, m-cresol, chloroform, cyclohexanone, pyridine, dimethylsulfoxide, and any mixtures thereof.
